(19) United States
(12) Patent Application Publication
(10) Pub. No.: US 2002/0083427 A1
(43) Pub. Date: Jun. 27, 2002

(54) Embedded system capable of rapidly updating software and method for rapidly updating software of embedded system

(76) Inventor: Chen-Pang Li, Taipei (TW)

Correspondence Address: BACON & THOMAS, PLLC, 625 Slaters Lane - 4th Floor, Alexandria, VA, 22314-1176, US

(21) Appl. No.: 09/745,932

(22) Filed: Dec. 26, 2000

(51) Int. Cl. G06F 9/00; G06F 9/24; G06F 15/177; G06F 9/44

(52) U.S. Cl. 717/169

(57) ABSTRACT

An embedded system capable of rapidly updating software and method for quickly updating software of embedded system are disclosed. The system comprises a memory device for storing a boot loader and a removable storage device for storing a software to be updated in the memory device. After the system has been reset, the boot loader is executed to initialize the embedded system for determining whether there is a boot loader script file in the removable storage device. If yes, the software in the removable storage device is copied to the memory device based on the content of the boot loader script file.

### BACKGROUND OF THE INVENTION

1. Field of the Invention

The present invention relates to the field of embedded systems and, more particularly, to an embedded system for rapidly updating software and method for quickly updating software of an embedded system.

2. Description of Related Art

Conventionally, it is required for embedded system to frequently update its flash memory through a communication device for determining whether a new program is correct during a software developing process. As to the scheme of writing software into flash memory of embedded system through a high-speed communication device used as a medium, the design of the required circuit and writing software is complicated. Furthermore, a powerful processor and a large amount of memories are required. Hence, the developing cost and time are both negatively affected. As such, most embedded systems do not incorporate high-speed communication devices due to the consideration of high cost and the complexity of circuitry. In addition, the communication protocol employed by a high-speed communication device is complex, and thus the writing software itself is not suitable for an embedded system having small memory space and low throughput.

If a simple low speed communication device is used as a medium, the performance of the writing software will be degraded due to the limitation of bandwidth in communication which usually results in a long waiting time for download and wasting the time of the programmer. Therefore, it becomes an important object to be able to quickly update the software of the embedded system to mitigate and/or obviate the aforementioned problems.

### SUMMARY OF THE INVENTION

An object of the present invention is to provide an embedded system capable of rapidly updating software, wherein a removable storage device is used as medium for updating the software of the embedded system, thereby simplifying the design of the circuit of the embedded system.

Another object of the present invention is to provide a method for rapidly updating software of an embedded system, which utilizes a removable storage device as medium for updating the software of the embedded system, thereby shortening the time required for developing the embedded system software.

In accordance with one aspect of the invention, there is provided an embedded system capable of rapidly updating software. The embedded system comprises: a central processing unit; a memory device pre-stored with a boot loader starting from a reset address; and a removable storage device for storing a software prepared to be updated in the memory device; wherein, after the embedded system is reset, the central processing unit executes the boot loader to determine whether there is a boot loader script file in the removable storage device after initializing the embedded system, and if yes, copies the prepared software in the removable storage device to the memory device based on the content of the boot loader script file.

In accordance with another aspect of the invention, there is provided a method for rapidly updating software of an embedded system. The embedded system includes a memory device and a removable storage device. The memory device is pre-stored with a boot loader starting from a reset address. The method comprises the steps of: (A) preparing a software to be updated in the memory device; (B) resetting the embedded system to execute the boot loader for initializing the embedded system; (C) determining whether to enter an updating mode, and if yes, executing step (D), otherwise, executing system software; (D) determining whether there is a boot loader script file in the removable storage device, and if yes, executing step (E), otherwise, displaying an error message; and (E) copying the software in the removable storage device to the memory device based on the content of the boot loader script file.

Other objects, advantages, and novel features of the invention will become more apparent from the detailed description when taken in conjunction with the accompanying drawings.

### BRIEF DESCRIPTION OF THE DRAWINGS

FIG. 1 is a block diagram illustrating an embedded system capable of rapidly updating software according to the invention;

FIG. 2 depicts a memory arrangement of the embedded system capable of rapidly updating software according to the invention;

FIG. 3 is a flow chart illustrating a method for rapidly updating software of an embedded system according to the invention; and

FIG. 4 depicts the content of a boot loader script file according to the invention.

### DETAILED DESCRIPTION OF THE PREFERRED EMBODIMENT

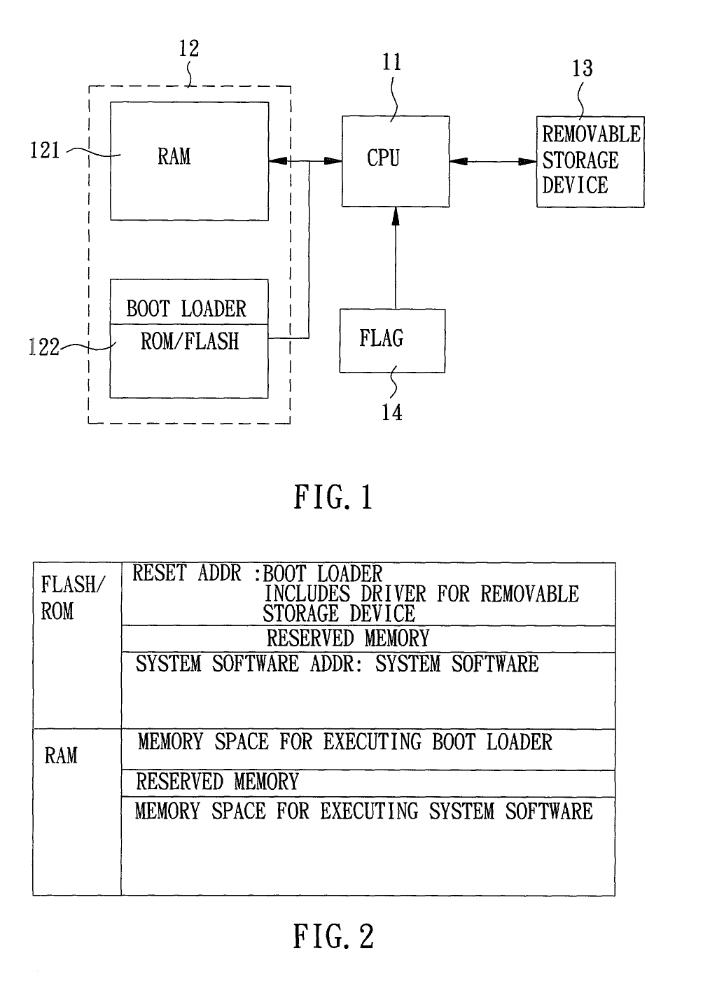

With reference to FIG. 1, there is shown a preferred embodiment of an embedded system for rapidly updating software in accordance with the present invention, which includes a central processing unit (CPU) 11, a memory device 12, and a removable storage device 13. The CPU 11 is a control center of the embedded system. The memory device 12 comprises a random access memory (RAM) 121 and a non-volatile memory (e.g., flash memory or read only memory) 122. The removable storage device 13 is implemented as Compact Flash, Smart-Media, Memory Stick, or SD, etc.

With reference to FIG. 2, there is shown a memory arrangement of the memory device 12. Starting from a reset address of the non-volatile memory 122, there is stored a boot loader including a driver for the removable storage device 13. The other memory space of the nonvolatile memory 122 is configured as address of system software and reserved for other purposes. As to memory space of the RAM 121, it is configured as the execution space of the boots loader, reserved for other purposes, and the execution space of the system software.

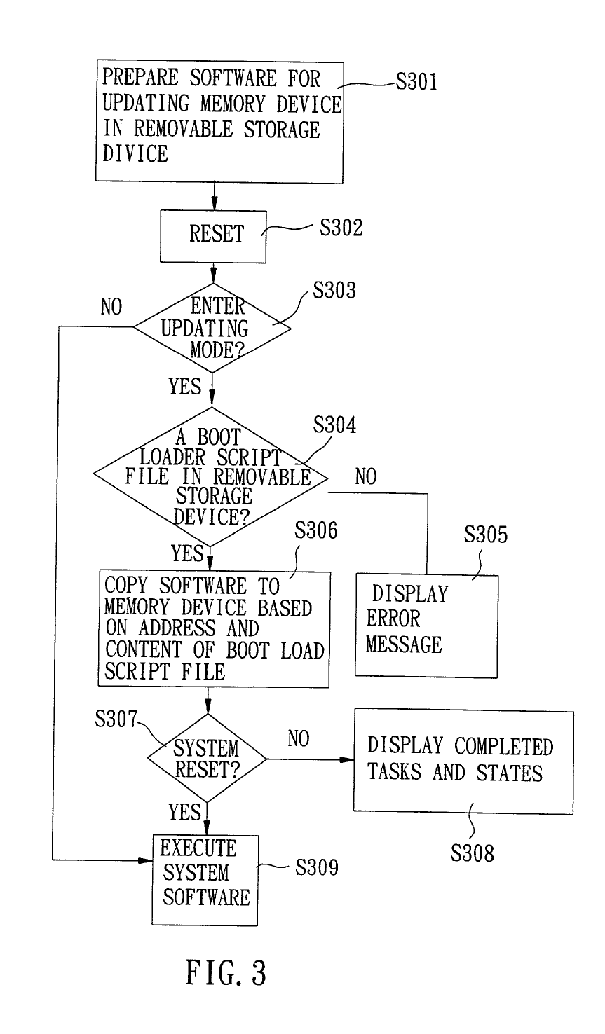

The removable storage device 13 is used to store a software for updating the memory device 12 thereby providing a capability of quickly updating embedded system software. With reference to FIG. 3, a flow chart of a process for quickly updating the software of the embedded system according to the present invention is illustrated. In step S301, the software for updating memory device 12 is prepared in the removable storage device 13. In step S302, the embedded system is reset so as to execute the boot loader for initializing the embedded system and executing the driver for the removable storage device 13. Accordingly, the removable storage device 13 is driven after the embedded system has been initialized.

In step S303, it is determined whether to enter an updating mode by referring to a flag 14 (see FIG. 1) set by the user. If the flag 14 is not set, the software is not updated and step S309 is executed to run the system software. If the flag 14 is set, step S304 is executed to determine whether there is a boot loader script file in the removable storage device 13. If no, it is indicated that the removable storage device 13 can not provide the software for updating, and thus an error message indicating no update software available in removable storage medium 13 is displayed.

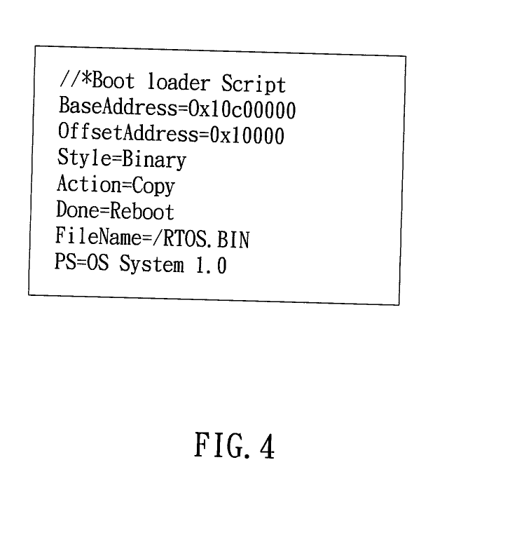

FIG. 4 depicts an example of the boot loader script file according to the invention. As shown, there are provided a base address (e.g., 0x10c00000) and an offset address (0x10000) for specifying the starting address of the software to be updated in the memory device 12. Furthermore, a file name of the software (e.g., RTOS.BIN), style (e.g., Binary), and action to be taken (e.g., copy) are also provided. With such information, the CPU 11 is able to update software. Referring to FIG. 3 again, if step S304 determines that there is a boot loader script file in the removable storage device 13, a predetermined software in removable storage device 13 is copied to the memory device 12 based on the address and content of the file to be copied as described in boot loader script file (step S306).

After copying file and completing the update of the embedded system, step S307 is executed to determine whether the embedded system is needed to be reset. If yes, the system is reset and the system software is executed (step S309). If not, step S308 is executed to display the completed tasks and states thereof.

In view of above, it is appreciated that the present invention utilizes a removable storage device as a medium for updating the software of an embedded system, so as to provide several advantages as follows:

(1) The design of circuit is much simplified, resulting in a reduction in the developing cost and time.

(2) The writing program has a simple structure and high portability, and requires less resource.

(3) The time to write software is relatively short, thereby decreasing the software developing time, simplifying the writing procedure and easing the use of the writing program.

(4) There in no need to use an additional control device (e.g., a personal computer) for transmitting data in the writing process, thereby reducing the manufacturing cost and increasing the popularity among users.

(5) The manufactured products can also utilize the removable storage device, so that the time spent in developing the products is not wasted.

Although the present invention has been explained in relation to its preferred embodiment, it is to be understood that many other possible modifications and variations can be made without departing from the spirit and scope of the invention as hereinafter claimed.

What is claimed is:

1. An embedded system capable of rapidly updating software, comprising:
a central processing unit;
a memory device pre-stored with a boot loader starting from a reset address; and
a removable storage device for storing a software prepared to be updated in the memory device;
wherein, after the embedded system is reset, the central processing unit executes the boot loader to determine whether there is a boot loader script file in the removable storage device after initializing the embedded system, and if yes, copies the prepared software in the removable storage device to the memory device based on the content of the boot loader script file.

2. The embedded system as claimed in claim 1, wherein the boot loader comprises a driver for the removable storage device so as to drive the removable storage device after initializing the embedded system.

3. The embedded system as claimed in claim 2, wherein the boot loader script file comprises a file name, a starting address, and an action to be taken after copying.

4. The embedded system as claimed in claim 1, wherein the memory device further comprises a random access memory, and a non-volatile memory for storing the boot loader.

5. The system as claimed in claim 1, wherein the removable storage device can be a Compact Flash, a Smart-Media, a Memory Stick, and a SD.

6. A method for rapidly updating software of an embedded system, the embedded system including a memory device and a removable storage device, the memory device being pre-stored with a boot loader starting from a reset address, the method comprising the steps of:
(A) preparing a software to be updated in the memory device;
(B) resetting the embedded system to execute the boot loader for initializing the embedded system;
(C) determining whether to enter an updating mode, and if yes, executing step (D), otherwise, executing system software;
(D) determining whether there is a boot loader script file in the removable storage device, and if yes, executing step (E), otherwise, displaying an error message; and
(E) copying the software in the removable storage device to the memory device based on the content of the boot loader script file.

7. The method as claimed in claim 6, wherein, in step (B), a driver for the removable storage device included in the boot loader script file is also executed for driving the removable storage device after initializing the embedded system.

8. The method as claimed in claim 7, wherein, in step (C), it is determined whether to enter the updating mode based on a flag.

9. The method as claimed in claim 7, further comprising a step (F) for determining whether to reset the embedded system, and if yes, executing the system software, otherwise, displaying completed tasks and states thereof.
